(19) United States
(12) Patent Application Publication
(10) Pub. No.: US 2006/0010446 A1
(43) Pub. Date: Jan. 12, 2006

(54) Method and system for concurrent execution of multiple kernels

(76) Inventors: Rajiv S. Desai, Brea, CA (US); Jaswinder Singh Rajput, New Delhl (IN)

Correspondence Address: BAY AREA INTELLECTUAL PROPERTY GROUP, LLC, PO BOX 210459, SAN FRANCISCO, CA, 94121-0459, US

(21) Appl. No.: 11/169,542

(22) Filed: Jun. 29, 2005

Related U.S. Application Data
(60) Provisional application No. 60/586,486, filed on Jul. 6, 2004.

(51) Int. Cl. G06F 9/46

(52) U.S. Cl. 718/100

(57) ABSTRACT

An approach for concurrently running multiple kernels using a common interrupt handler and an optional common scheduler is provided. Techniques are also provided to switch execution among the kernels. Execution and interrupt preemption among kernels in shown using interrupt mask levels. Techniques are also provided for the sharing of resources between tasks running on different kernels.

### CROSS-REFERENCE TO RELATED APPLICATIONS

The present Utility patent application claims priority benefit of the U.S. provisional application for patent No. 60/586,486 filed on Jul. 6, 2004 under 35 U.S.C. 119(e).

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### FIELD OF THE INVENTION

The present invention relates generally to multitasking operating systems. More particularly, the invention relates to Supporting features of multiple kernels in a single operating system by allowing execution of multiple kernels using common interrupt handler and scheduler.

### BACKGROUND OF THE INVENTION

Operating systems are designed and their operations are typically optimized based on specific applications for which they are used. Often it is desirable to have features of one type of operating system available in another.

For example, general-purpose computer operating systems such as Linux and Windows have an extensive set of features such as file systems, device drivers, applications, libraries etc. Such operating systems allow concurrent execution of multiple programs, and attempt to optimize the response time (also referred to as latency time) and CPU usage, or load, associated to the servicing of the concurrently executing programs. Unfortunately, however, such operating systems are not generally suitable for embedded, real-time applications; such as, for example, control of robots, telecommunication systems, machine tools, automotive systems etc. Real-world, event and control based applications such as these, and many others, require what is known as hard real-time performance. Hard real-time performance guarantees worst-case response times. General purpose operating systems (GPOS) typically compromise predictability of program execution time for average performance of application programs. Several known real-time operating systems (RTOS) including iTRON™, and the like, offer hard-real time features. However, regrettably, most RTOS do not have many GPOS features, and, for example, do not provide support for different file systems, device drivers, application libraries, and etc. In many applications it would be desirable to have the performance of an RTOS and features of general-purpose operating systems.

Linux, for example, is a well known general purpose operating system with many desirable features for modern devices including modern operating systems features, numerous development tools, networking, etc. However, Linux was not designed to be an embedded operating system. Many modern devices, such as, without limitation, set top boxes, mobile phones, and car navigation system require not only the features of a general purpose operating system such as Linux but also the features of embedded operating system like real-time performance.

iTRON, for example, is a mature real-time embedded operating system commonly used in numerous embedded devices. iTRON has many of the features desirable for a embedded devices but it lacks the features of Linux such as networking, support for different file systems etc.

An exemplary need of both a GPOS and a RTOS is a controller for navigation system used in automobiles. The controller reads data from the GPS sensors to compute the location and orientation of the automobile. Based on current location, destination and topological map extracted from a navigation data DVD, the controller computes the best path and displays on LCD screen. Tile LCD screen may be overlaid with a touch panel for inputting, parameters to navigation systems. The tasks of reading sensors, touch panel inputs require hard real-time; the tasks of computing path, displaying graphics, reading from DVD are standard programming tasks and use features of general purpose operating systems. Tile hard real-time performance can be achieved by using a RTOS kernel such as iTRON while the general purpose tasks can be run on Linux kernel.

Another exemplary need is a controller for solid-state digital video camera using video data compression hardware. In such as application, it is desirable to read the data stream coming from compression hardware and perform image processing functions, while displaying on an LCD screen and storing the data on removable storage media. It may also be necessary, for example, to use the same control system to manage the optical zoom and auto-focus mechanisms. If the system uses some legacy components there may already be extensive control software available for particular RTOS (e.g. iTRON). Tasks of controlling the motors, data collection and storage may be handled best by a hard-real time operating system (hRTOS) while the display, image processing and other functions may be better managed by standard programming, typically under a GPOS. Moreover, it is typically too costly to port the extensive software available in iTRON to another RTOS, and providing display and file system support, etc., in iTRON may likewise not be simple. Hence, in this example, a system that combines the strengths of RTOS and a general-purpose operating system would be optimal for this application.

Another exemplary need is in systems that require use of special purpose hardware for acceleration of a specific function or addition of a specific functionality. For instance, in many multimedia devices it is necessary to use a graphics accelerator chip or a DSP or CODEC for audio or video. In some instances need for additional hardware could be eliminated if the operating system could provide guaranteed performance for some tasks. For example, in a system that supports streaming audio, it may be necessary to have a high performance tasks that guarantee decoding of compressed and encoded audio at certain rate to avoid packet loss and maintain certain quality of output. A system consisting of GPOS and RTOS may in some cases be able to eliminate the need for specialized hardware thereby reducing the cost of product.

All real world systems can be classified as either hard real-time (HRT), soft real-time (SRT) or non real-time (NRT) systems. A hard real-time system is one in which one or more activities must never miss a deadline or a timing constraint, otherwise the task is said to have failed. A soft real-time system is one that has timing requirements, but occasionally missing them has negligible effect, so long as application requirement as a whole continue to be met. Finally, a non-real time system is one that is neither hard real-time nor soft real-time. A non real-time task does not have any deadline or timing constraints. In many of the modern applications it is necessary to support full spectrum of real-time system performance. For example, consider the requirements of a network appliance for security application. A network appliance may have to sample every network packet over a high speed network connection without missing single packet (a hard real-time task). A hard real-time task would deposit these packets in a buffer to be processed later. This can be achieve using a hRTOS. These packet samples in the buffer would have to be processed and classified but occasionally if the processing and classification slows down there would not be a problem as long as the buffer does not overflow (a soft real-time task). This can be achieved using combination of tasks in hRTOS and GPOS. A web server may be used for delivering the processed and classified data upon request. There is generally no timing constraint on this activity (i.e. a non real-time task); hence, this task can be performed in GPOS.

In view of the foregoing, there is a need for a system implementing a multi-kernel environment (e.g., GPOS and RTOS) that efficiently and conveniently provides the performance and features of multiple kernels and supports a full spectrum of real-time performance.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates a diagrammatic view of an exemplary architecture that enables running multiple kernels on one hardware platform, in accordance with an embodiment of the present invention;

FIG. 2 illustrates a flow chart of method for concurrently running multiple kernels, in accordance with an embodiment of the present invention;

FIG. 3 illustrates a flow chart of an exemplary method for the selection of the Primary kernel described in FIG. 2, in accordance with an embodiment of the present invention;

FIG. 4 illustrates a flow chart of an exemplary method for starting the primary kernel described in FIG. 2 in accordance with an embodiment of the present invention;

FIG. 5 illustrates a flow chart of an exemplary method for the selection and adding of the secondary kernel(s) described in FIG. 2, in accordance with an embodiment of the present invention;

FIG. 6 illustrates a flow chart of an exemplary method for starting the secondary kernel described in FIG. 2, in accordance with an embodiment of the present invention;

FIG. 7 illustrates a block diagram of an exemplary architecture for a common interrupt handler and common scheduler for multiple kernels, in accordance with an embodiment of the present invention;

FIG. 8 illustrates an exemplary diagrammatic chart of the interrupt mask levels for multiple kernels, in the context of FIG. 7, and in accordance with an embodiment of the present invention

FIG. 10 illustrates a flow chart of an exemplary method for the switching of kernels by way of a periodic signal, in accordance with an embodiment of the present invention;

FIG. 11 illustrates an exemplary block diagram of an embodiment of the present invention where a common system call is used for multiple kernel resource sharing; and

FIG. 12 illustrates a typical computer system that, when appropriately configured or designed, can serve as a computer system in which the invention may be embodied.

Unless otherwise indicated illustrations in the figures are not necessarily drawn to scale.

### SUMMARY OF THE INVENTION

To achieve the forgoing and other objects and in accordance with the purpose of the invention, a variety of techniques are provided for the concurrent execution of and sharing of resources between multiple kernels.

A method, system, computer code, and means for the concurrent execution of multiple kernels in a multi-kernel environment is described. In one method embodiment of the present invention, a primary and at least one secondary kernel are configured, at least one secondary kernel being tinder at least partial control of the primary kernel, and an optional common scheduler is configured that schedules execution of processes pending in the primary and at least one of the secondary kernels, and a common interrupt handler is configured that handles the interrupts and execution of interrupting processes in the primary and at least one of the secondary kernels. Means are also provided, in accordance with another embodiment, for implementing the forgoing method. Computer code is also provided, in accordance with yet another embodiment, for implementing the forgoing method.

Another method embodiment of the present invention is provided for sharing system resources between multiple kernels in a multi-kernel environment, wherein, a primary and at least one secondary kernel are configured, at least one secondary kernel being under at least partial control of the primary kernel, and an application program interface (API) for system resource sharing between the kernels is configured, the calling kernel being provided with an appropriate dummy API call for at least some of the other kernels. Means are also provided, in accordance with yet another embodiment, for implementing this method. Computer code is also provided, in accordance with yet another embodiment, for implementing this method.

Other features, advantages, and object of the present invention will become more apparent and be mole readily understood from the following detailed description, which should be read in conjunction with the accompanying drawings.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments.

One aspect of the present invention that will be described in some detail below is to operate two or more operating system kernels while retaining the features and capabilities of both operating system kernels.

In general, there may be number of motivations for developing a multi-kernel system. Four reasons are:
1. Performance Characteristics of one kernel may be desirable in another (e.g. real-time functionality may be desirable in a general purpose operating system.)
2. Features of one operating system (or kernel) may be desirable in another (e.g. file systems, device drivers, real-time API, libraries)
3. In some cases, eliminate the need for specialized hardware through use of a multi-kernel system, thereby reducing the cost of product
4. There may be a need for a system consisting of hRTOS and GPOS that can support full spectrum of real-time performance.

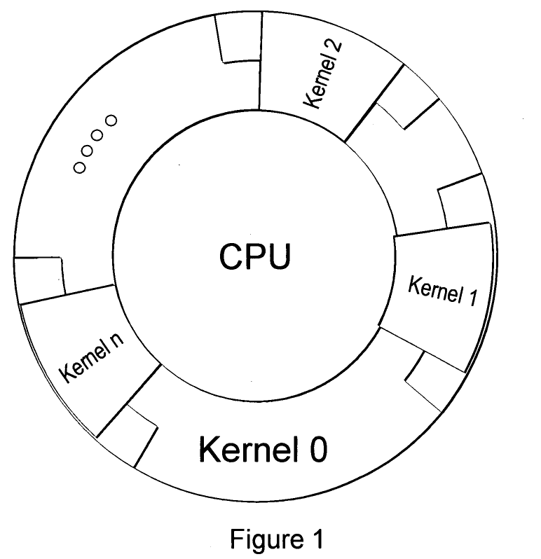

FIG. 1 illustrates a diagrammatic view of an exemplary architecture that enables running multiple kernels on one hardware platform, in accordance with an embodiment of the present invention. As shown in the Figure, multiple kernels labeled Kernel0, Kernel1, Kernel2, Kerneln, are executing on a conventional central processing unit labeled “CPU.” It should be appreciated that although the Figure and the following disclosure show and discuss embodiments and examples in the context of a single CPU system, the present invention is not limited to single CPU implementations and may be suitably configured, in light of the teachings of the present invention and according to known techniques, to properly perform the teachings of the present invention using a multi-CPU system. Kernel0 is herein referred to as the Primary kernel, and kernels Kernel1, Kernel2, . . . , Kerneln represent a certain number of kernels being executed by Kernel0, the number of which may generally be limited by system resources. The kernels may belong to a general-purpose operating system (GPOS) or a real-time operating system (RTOS), and each may vary widely in its features and capabilities provided.

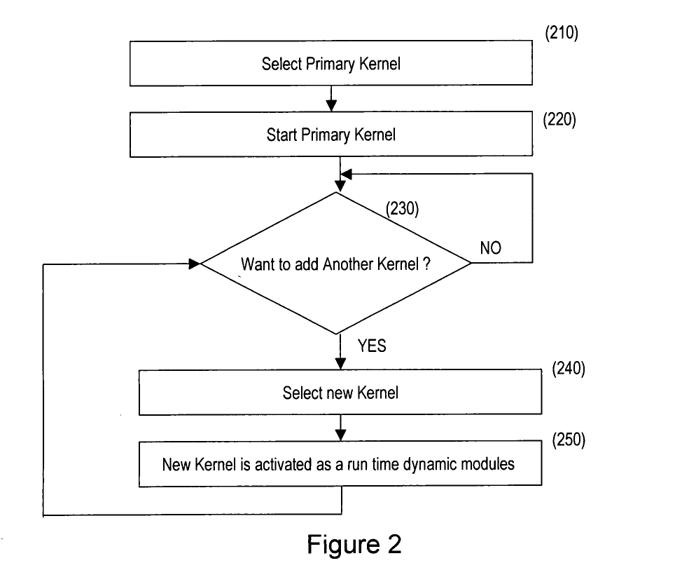

A Selection of Kernels aspect of the present invention will next be described in some detail. FIG. 2 illustrates a flow chart of method for concurrently running multiple kernels, in accordance with an embodiment of the present invention. Each step in the present process shown will be separately exemplified in more detail in the subsequent Figures. The process begins by selecting as the primary kernel (Kernel 0) the kernel (e.g., those of FIG. 1) of the general-purpose operating system or operating system with most capabilities and features is selected at Step 210 and started at Step 220 In the context of the present example, starting the kernel includes, powering up the hardware, loading the bootloader which loads or executes in place the Kernel 0. Kernel 0 upon starting starts the interrupt handler, scheduler, task manager etc. and initializes the system hardware by installing appropriate drivers. Next, at Step 230, kernels with specific features desired for a given target application that are not available, or otherwise desirable, in the primary kernel are added as dynamic modules of the primary kernel. (e.g., Kernel 1, Kernel 2, . . . , Kernel n). This process loops at Step 230 back to Step 230 until all the desired kernels are added.

Each secondary kernel is preferably assigned a unique kernel identification means (ID) upon activation, the utility of which identification will be exemplified in some detail below. These kernel IDs are preferably pre-assigned. At Step 240, the added kernel is selected by primary kernel according to preassigned interrupt mask and kernel id, afterwards at Step 250 the added, or secondary, kernels Kernel 1, Kernel 2, . . . , Kernel n is activated as a dynamic module.

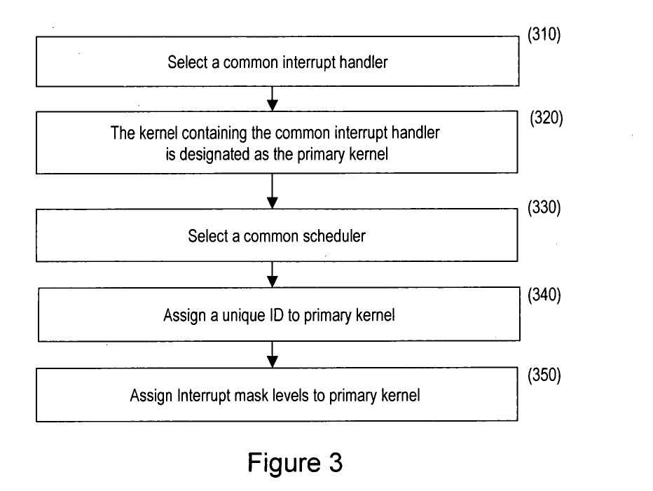

FIG. 3 illustrates a flow chart of an exemplary method for the selection of the Primary kernel described in FIG. 2, in accordance with an embodiment of the present invention. The process begins at Step 310 with selecting a common interrupt handler with the most desirable capabilities and features. Then at Step 320 the kernel to which the common interrupt handler belongs is designated the primary kernel. In Step 330 a scheduler is selected as a common scheduler. This scheduler may be the scheduler of the primary kernel or any other kernel. Depending upon the needs of the particular application, alternate embodiments of the present invention may implement or otherwise enable the primary kernel and/or the present system to use any suitable interrupt handler or scheduler. In yet other embodiments of the present invention, there may be no primary, controlling kernel, and instead all kernels in the multi-kernel system are controlled by the common task scheduler and common interrupt handler, and do not directly control each other. In yet other embodiments of the present invention, the interrupt handler of the primary kernel may not be used, and, instead, another interrupt handler is implemented outside the primary kernel, in which situation an interrupt handler emulator may be implemented according to known techniques, and other novel aspects of the present invention may be, otherwise, implemented. It is to be understood that in the present embodiment, the kernel which whose default interrupt handler is used for the common interrupt handler automatically becomes the primary kernel of the multi-kernel system. It is to be further understood that in some applications the system designer may choose to remove the default interrupt handler of the primary kernel and replace it with another interrupt handler, wherein either case, the effective interrupt handler available to the primary kernel is deemed to be part of that kernel for the purposes of the present embodiment. A multiplicity of other suitable implementation variations for the common interrupt handler in accordance with the teachings of the present invention will become readily apparent to those skilled in the art.

Returning to the Figure, a unique ID and interrupt mask levels are assigned to the primary kernel at Step 340, and Step 350, respectively. Interrupt mask levels will be described in some detail below

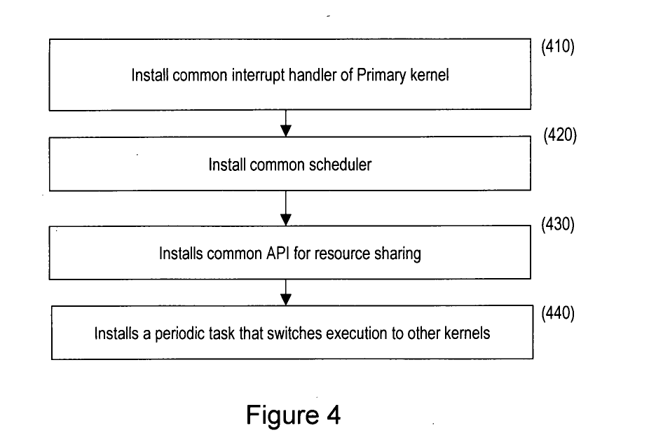

FIG. 4 illustrates a flow chart of an exemplary method for starting the primary kernel described in FIG. 2, in accordance with an embodiment of the present invention. The process begins at Step 410 with installing the common interrupt handler of the primary kernel. Then at Step 420 the common scheduler is installed. At Step 430 a common application program interface (API) is installed for resource sharing. It is not known beforehand if there are going to be one or more secondary kernels or what specific resources of selected secondary kernels will be available for resource sharing. A common API for resource sharing allows unlimited sharing of resources without prior knowledge of the details of the resource APIs. At Step 440 a periodic task, or process, is installed that switches execution to secondary kernels according to a desired switching scheme that depends on the particular application. In the preferred embodiment, the switching between kernels is triggered by a hardware timer interrupt. Depending upon the needs of the particular application, those skilled in the art may devise other suitable switching, possibly a periodic or event driven, schemes in light of the teachings of the present invention. By way of example, and not limitation, of suitable kernel switching schemes including periodic, a periodic, event based, priority based schemes may be used for switching between kernels.

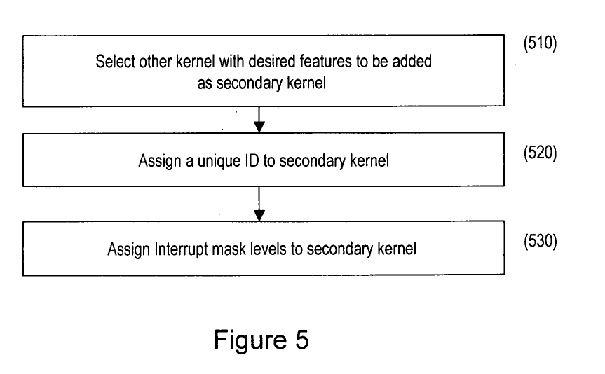

FIG. 5 illustrates a flow chart of an exemplary method for the selection and adding of the secondary kernel(s) described in FIG. 2, in accordance with an embodiment of the present invention. The process begins at Step 510 with selecting a secondary kernel having the set of desirable capabilities and features which are derived from the requirements of the system in which the multi-kernel software will be installed. A unique ID and interrupt mask levels are assigned to the secondary kernel at Step 520, and Step 530, respectively.

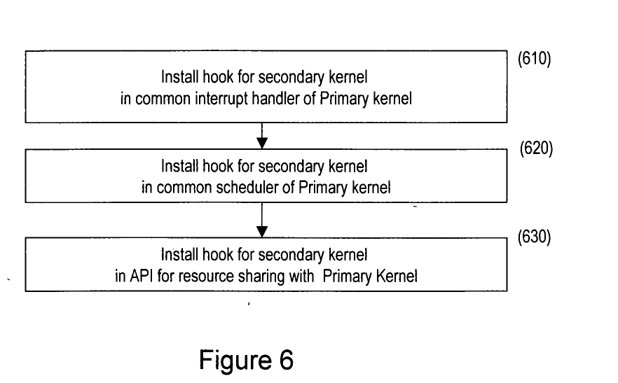

FIG. 6 illustrates a flow chart of an exemplary method for starting the secondary kernel described in FIG. 2, in accordance with an embodiment of the present invention. The process begins at Step 610 with installing what is known as a ‘hook’ for the secondary kernel into the common interrupt handler of the primary kernel. Then at Step 620 a hook for secondary kernel is installed into the common scheduler. In Step 630 a hook for secondary kernel is installed into common application programming interface (API). The hook enables a control path from a controlling application (e.g., the interrupt handler or the scheduler or the common API) in the primary kernel to the particular secondary kernel the hook is associated with.

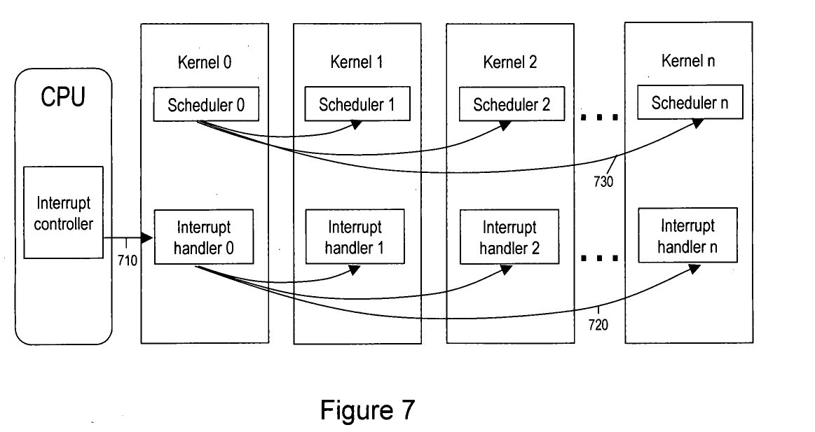

An Interrupt Masking and Kernel Priority aspect of the present invention will next be described in some detail. All modern computing systems have interrupts that can be selectively enabled or disabled. An interrupt mask level determines which interrupts are allowed and which are not allowed to interrupt the processor. FIG. 7 illustrates a block diagram of an exemplary architecture for a common interrupt handler and common scheduler for multiple kernels, in accordance with an embodiment of the present invention. In Figure, the mask level for Kernel 0 is such that all interrupts are allowed. In the preferred embodiment of the present invention, each secondary kernel is assigned a range of interrupts that are enabled only when that kernel is running. In the present embodiment, this is achieved by use of mask levels.

Most modern processors support interrupt-mask-levels. As indicated above, kernel mask level determines which interrupts are allowed by a kernel and which ones are not allowed. However, it should be noted that even though interrupts may be allowed by a kernel, it may not be handled by it. Thus, the present embodiment has three interrupt conditions with respect to a kernel and an interrupt: (1) The interrupt may be blocked (2) interrupt may be allowed but not processed, and (3) interrupt may be allowed and processed (handled) by the kernel. The interrupts that are allowed and handled by a certain kernel are said to be assigned to that kernel. Again, all interrupts are allowed and handled by Kernel 0. Each interrupt may also be assigned uniquely to any other kernel. Hence, under the approach of the present embodiment, an interrupt must be allowed and handled by kernel 0 and may be allowed and handled by one and only one other kernel. Some embodiments of the present invention further provide the interrupts with priorities, which priorities may be dictated by the design of the CPU, or by other means known to those skilled in the art.

In a typical application of the present embodiment, during the design of the multi-kernel system the priority of the interrupts are preferably designated such that highest priority interrupts are assigned to the kernel with highest priority of execution. As shown in the Figure, Kernel 1 has higher priority than kernel 0, kernel 2 has higher priority than kernel 1, and so on. Kernel n has the highest priority. Thus, kernel 0 can be preempted by kernel 1, kernel 2, . . . , kernel n. kernel 1 can be preempted by kernel 2 invent through kernel n. kernel n cannot be preempted by any kernel. Other alternative and suitable interrupt prioritization schemes will be readily become apparent to those skilled in the art in light of the teachings of the present invention.

The interrupt handling aspect of the present invention will next be described in some detail. A novel aspect of the present invention is that a common interrupt handler is selected first. The kernel with which the common interrupt handler is associated is referred to the primary kernel. In the preferred embodiment, all interrupts are handled by kernel 0 interrupt handler. Upon receiving the interrupt (710), kernel 0 executes the non-kernel specific interrupt service routine and then passes control to interrupt handler of kernel to which the specific interrupt is assigned. Referring again to the Figure, when interrupt N, which is assigned to Kernel n, occurs, it is first handled by the kernel 0 handler, then Kernel n's interrupt service routine is invoked, in which case Kernel n is referred herein to be the target kernel (720). It should be noted that when the interrupt handler is invoked, the interrupt handler executes kernel independent interrupt handling functions; and, passes the control to the interrupt service routine of the target kernel. The target kernel is preferably identified using interrupt mask levels. In this way, the interrupt handler of Kernel 0 acts as the common interrupt handler for the multi-kernel system.

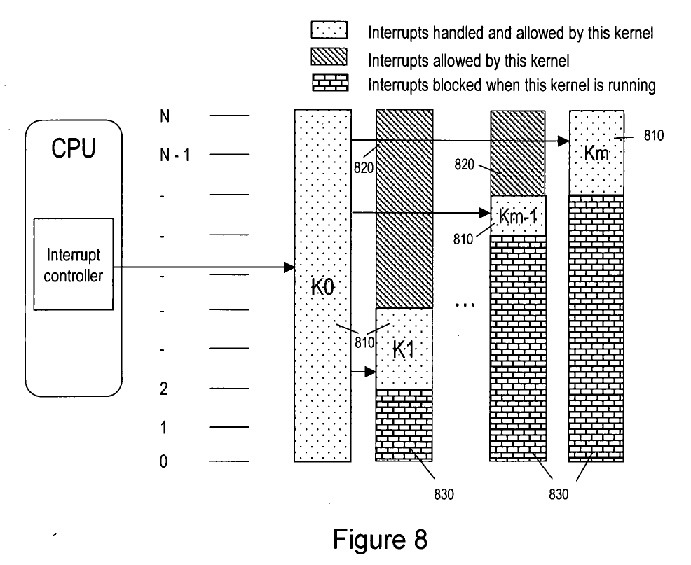

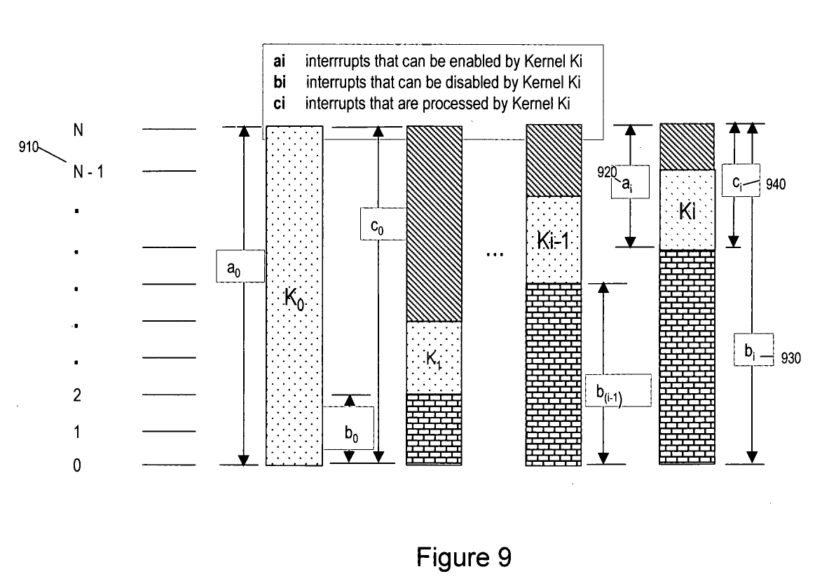

FIG. 8 illustrates an exemplary diagrammatic chart of the interrupt mask levels for multiple kernels, in the context of FIG. 7, and in accordance with an embodiment of the present invention. The figure shows how interrupt mask levels in the present embodiment are used to determine the target kernel for each interrupt. The interrupt number is shown as ascending numbers on the left side, or axis, of the chart, with N being the total number of interrupts.

The dotted (or mostly void) areas (810) of the vertical bars show the interrupts handled and allowed by the respective Kernel. The hatched areas (820) show the interrupts allowed by the respective Kernel. The brick textured areas (830) show the interrupts blocked when the respective Kernel is running, i.e., in control of CPU time.

FIG. 9 illustrates further aspects of the interrupt mask levels for multiple kernels shown in the block diagram of FIG. 2 and bar chart of FIG. 8, in accordance with an embodiment of the present invention. Shown in the Figure is an example of how mask levels determine which interrupts can are to be processed by the kernel, which interrupts can be disabled by a kernel and which interrupts can be enabled by a given kernel. The interrupt number is shown as ascending numbers on the left side, or axis, of the chart (910), with N being the total number of interrupts.

In particular, the i'th kernel denoted as Ki in the vertical bar at the far right bar, and ‘ai’ (920) indicates the interrupts that can be enabled by Kernel Ki, ‘bi’ (930) the interrupts that can be disabled by Kernel Ki, and ‘ci’ (940) the interrupts that are processed by Kernel K

A Scheduling aspect of the present invention will next be described in some detail. In most conventional operating systems the scheduler is periodically invoked using a hardware timer. Hardware timer is typically set to trigger a periodic interrupt to initiate a scheduling event. Each kernel, in a multi-kernel system, may have a different period for invoking scheduler depending on the purpose of the operating system. For example, without limitation, in the case of a general purpose operating system a 10 millisecond period may be sufficient for desired performance. However, in the case of a real-time kernel it may be necessary to have a scheduling event after every 100 microseconds.

In the present embodiment, a common scheduler is selected for the multi-kernel system. All scheduling events are preferably first received by the common scheduler. After executing the kernel independent scheduling functions, the scheduler preferably passes the control the scheduler of the currently running kernel (730). For the purposes of this example, the kernel running currently is defined as the kernel that was running when scheduling event occurred.

A multi-kernel execution aspect of the present invention will next be described in some detail. Another novel aspect of the present invention is that even when higher priority kernel is executing, the system allows execution of tasks in lower priority kernels—when opportunity arises (i.e. tasks in high priority kernel are not in running state—e.g. waiting, sleeping, dormant, . . . , etc.).

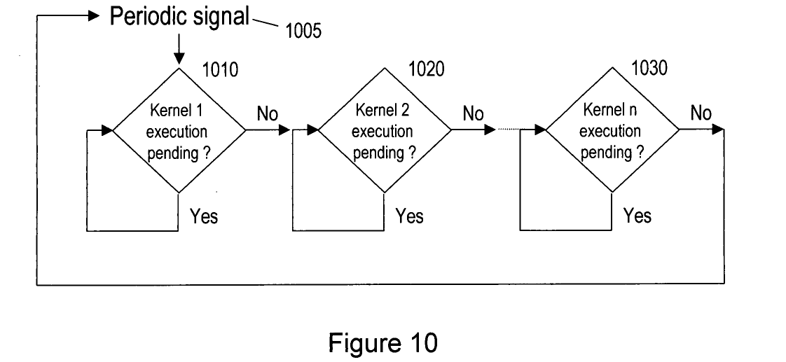

FIG. 10 illustrates a flow chart of an exemplary method for the switching of kernels by way of a periodic signal, in accordance with an embodiment of the present invention. In the embodiment shown in the Figure, the general purpose kernel (kernel 0, not shown) runs a periodic process that switches from one kernel to another by the generation of a periodic signal at Step 1005 invention that the triggers the kernel switching process, whereby the process proceeds to first determine there are any pending tasks in another kernel. This may be achieved by many suitable approaches; one suitable approach is shown in the figure where a serial polling methodology is employed to determine if a kernel in the chain has any pending tasks to execute. In the example shown, upon the generation of the periodic signal at Step 1005, invention Kernel 1 is polled for any pending tasks to execute. If Kernel 1 has one or more pending tasks to execute (the ‘Yes’ path), execution of the pending task(s) in Kernel 1 is effected by, for example, changing the currently running id to the id of Kernel 1 to thereby transfer CPU time for execution of the pending task(s). If Kernel 1 has no pending tasks to execute (the ‘No’ path), the process continues to poll the next Kernel; e.g., Kernel 2 invention at Step 1020, invention and the process continues in the same way for each subsequent Kernel in the chain until the last Kernel is reach, Kernel n at Step 1030. Once all pending tasks in the kernels have been executed or no pending tasks were found (i.e., the “No” paths through Steps 1010-1030) the process ends and execution of kernel 0 tasks is resumed. However, in some alternative embodiments of the present invention, instead of having to complete all pending tasks before returning control to the primary kernel, another polling or switching scheme may be implemented according to known techniques (e.g., without limitation, servicing only the highest priority kernels at first and then lower priority ones on subsequent passes, etc.) to service at least a portion of the pending processes before returning control back to the primary kernel. The process restarts upon the next generation of the periodic signal at Step 1005. Depending upon the needs of the particular application, those skilled in the art will recognize a multiplicity of alternative and suitable switching schemes in light of the teachings of the present invention.

A Multi-kernel Resource Sharing aspect of the present invention will next be described in some detail. Yet another novel aspect of the present invention is that resources may be shared between primary kernel and any of the secondary kernels and among secondary kernels. In many applications it is often desirable to access features and resources of one operating system kernel from the other. In some instances this may be the primary motivator to implement a multi-kernel system.

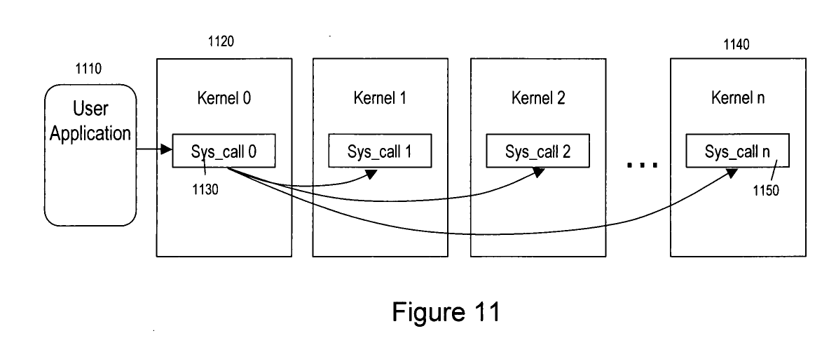

FIG. 11 illustrates an exemplary block diagram of an embodiment of the present invention where a common system API is used for multiple kernel resource sharing. In the present embodiment, multiple kernel resource sharing is achieved by way of a defining dummy API system call (e.g., Sys_call 1, Sys_call 2, . . . , Sys_call n) for each kernel that supports resource sharing (e.g., file systems, device drivers, libraries, etc.) between the primary kernel and the secondary kernel. In the preferred embodiment, the primary kernel has a dummy API call for each kernel for which the primary kernel supports resource sharing between primary kernel and secondary kernel. The dummy API call is replaced by actual API call when the secondary kernel is activated as a dynamic module of the primary kernel.

When an actual API call is executed from the primary kernel, the secondary kernel invokes the specific function call that corresponds to that API and runs the function under the secondary kernel. In this way, APIs of secondary kernel are made available to the primary kernel. Thus, applications (user and system) can access features of the secondary kernel. When a user application (1110) requests primary kernel (1120) to execute an API of kernel n. Primary kernel (1120) uses common API for resource sharing Sys_call0 (1130) to call the common API for resource sharing in kernel n (1140) Sys_calln. The common API for resource sharing in kernel n, Sys_calln (1150) calls the the specific API requested by the user application.

A specific embodiment of the present invention will be discussed below that exemplifies this process as applied to the Linux (GPOS), and iTRON (a RTOS) operating systems. It is understood that those skilled in the art will readily recognize how to properly configure any suitable GPOS and RTOS to operate in accordance with the teachings of the present invention. As recognized by the present invention, a hybrid system comprising a GPOS, such as the Linux kernel, and a RTOS, such as the iTRON kernel, would have features most desirable for many modern embedded devices.

In the context of the foregoing teachings, in the present embodiment, the Linux kernel is selected as the general purpose operating kernel (k0) and iTRON is selected as the secondary kernel (k1). The scheduler of Linux is selected as the common scheduler and the interrupt handler of Linux is selected as the common interrupt handler of the system, respectively. Upon booting the computer, Linux kernel is started first. The iTRON kernel is inserted as a run time dynamic module of Linux kernel. Unique kernel IDs 0 and 1 are assigned, for example, to Linux and to iTRON, respectively. The iTRON Kernel 1 could be assigned interrupt mask levels 11-15 in (suitable, for example, in Hitachi SH-4 implementations). Therefore, if, for example, the iTRON kernel is running interrupts with mask levels invention 1-10 interrupts are not allowed.

Because the Linux scheduler is used as the common scheduler for the system, the Linux scheduler is invoked by the system periodically using hardware timers. When a scheduling event is triggered, the Linux scheduler is invoked. The Linux scheduler determines the kernel id of the kernel that was running when the scheduler was invoked. If the running kernel was Linux then, for example, a linux_schedule( ) function is called, as exemplified by way of the following pseudo code:

#define DUET_NUM_KERNELS 2 /* Assuming two kernels(one
primary say Linux and one secondary say itron) */
#define DUET_NUM_POINTERS 3
typedef int (*duetptr)(unsigned long);
typedef int (*duetptr2)(signed long, unsigned long, unsigned long *, unsigned long
*);
int linux_do_IRQ(unsigned long);
int duet_running_kernel = 0;
int linux_sys_call(signed long function_id, unsigned long argc, unsigned long *
arg_type, unsigned long * arg_arr)
{
return 0;
}
duetptr duetptrarr[DUET_NUM_KERNELS][DUET_NUM_POINTERS] =
{

| | | | |
|---|---|---|---|
| {linux_schedule, linux_do_IRQ | , | 0 | }, |

| | | | | | | |
|---|---|---|---|---|---|---|
| { | 0 | , | 0 | , | 0 | } |

};
duetptr2 duetptr2arr[DUET_NUM_KERNELS][DUET_NUM_POINTERS] =
{

| | | | | | |
|---|---|---|---|---|---|
| {linux_sys_call | , | 0 | , | 0 | }, |

| | | | | | | |
|---|---|---|---|---|---|---|
| { | 0 | , | 0 | , | 0 | } |

```
};
asmlinkage int sys_duet_sys_call(signed long kernel_id, signed long function_id,
unsigned long argc, unsigned long *arg_type, unsigned long *arg_arr)
{
  if(duetptr2arr[kernel_id][2])
      return duetptr2arr[kernel_id][2](function_id, argc, arg_type, arg_arr);
  else
      return −200; /* Invalid Kernel */
}
asmlinkage void schedule(void)
{
  duetptrarr[duet_running_kernel][0](0);
}
```

Depending upon which kernel is running certain interrupts may be masked. For example, when the iTRON kernel is running all interrupts with mask level 1-10 (SH-4 implementation, for example) are masked. If interrupt with mask level 11-15 occurs, the Linux interrupt handler is invoked. The Linux interrupt handler executes non-iTRON specific code then executes the iTRON interrupt handler using do_IRQ, as exemplifies by way of the following pseudo code:

```
asmlinkage int do_IRQ(unsigned long r4, unsigned long r5,
            unsigned long r6, unsigned long r7,
            struct pt_regs regs)
{
    return duetptrarr[duet_running_kernel][1]((unsigned long)&regs);
}
```

In the present embodiment, if secondary kernels (such as iTRON) need to be installed, then primary kernel first installs a periodic signal whose purpose is to switch execution among kernels. This periodic signal may be triggered by a hardware timer. When this periodic signal occurs, the interrupt handler determines if there are any tasks pending execution in secondary kernel (iTRON), if there are none, it passes execution to the Linux kernel. This allows execution of tasks in primary kernel while secondary kernel is idling.

In the present embodiment, when primary kernel (e.g., the Linux kernel) passes the execution to secondary kernel (e.g., the iTRON kernel), it preferably first changes the interrupt mask levels to that of the secondary kernel (iTRON). For example, without limitations when the execution is transferred to iTRON the interrupt mask level is set by invoking linux_{—}2_itron( ) as shown below. This sets the interrupt mask at 0x000000A0. Now only interrupts between 11-15 would be allowed. If an interrupt with mask level 0-10 occurs, the interrupt is ignored, as exemplifies by way of the following pseudo code:

```
void linux_2_itron(void)
{
    /* Masking */
    duet_imasks = 0x000000A0;
    /* Set iTRON schedule, IRQ */
    duet_running_kernel = 1;
}
```

When the execution is transferred back from iTRON to Linux, the interrupt mask is set at 0x00000000, invention allowing all interrupts. It should be noted, that before the execution is transferred the kernel id is also changed to the id of the kernel to which the execution is being passed. For example, when the execution is passed from Linux to iTRON, the kernel id is changed from 0 to 1. When execution is returned to Linux, the kernel id is changed from 1 to 0, as exemplifies by way of the following pseudo code:

```
void itron_2_linux(void)
{
    /* Set linux schedule, IRQ */
    duet_running_kernel = 0;
    /* Unmasking */
    duet_imasks = 0x00000000;
}
```

The above system was implemented on a Hitachi SHx family processors. Hitachi SHx processors and many other processors support explicit interrupt priorities. In systems where interrupt priorities are not supported in the hardware, interrupt priorities may be implemented in software through emulation or some of the technique.

Most conventional real-time embedded systems use event based programming; i.e. tasks execute when specific events happen. In a well-programmed embedded computer system the system CPU is resting idle most of the time. Most, if not all, embedded applications can be viewed as consisting of three types of tasks; they are, Hard Real Time (HRT), Soft Real Time (SRT) and Non Real Time or Ordinary (NRT), which task model, and corresponding interrupt model, will be leveraged in an embodiment of the present invention that will next be described in some detail. In this context, another aspect of the present invention takes advantage of this typical idle time in embedded systems to increase the performance and duty cycle of the general purpose operating system. In one embodiment of the present invention that leverages the foregoing task model and system idle time, HRT tasks are implemented as tasks in the RTOS kernel(s), for example, without limitation, an iTRON kernel using an iTRON API; SRT tasks are implemented using the RTOS kernel(s), for example, without limitation, an iTRON API, and/or a GPOS kernel(s), for example, without limitation, Linux libraries (system calls and kernel API); and, NRT tasks are implemented using GPOS kernel(s), for example, without limitations standard Linux APIs.

The present embodiment is suitable for use with any combination of RTOS and GPOS systems that are known, or yet to be developed; however, for the sake of clarity the subsequent discussion will assume the RTOS is iTRON and the GPOS is Linux. According to the approach of the present embodiment, as long as there are tasks pending execution in iTRON kernel, Linux processes do not get a chance to be executed. If there is more than one task ready for execution, the task with the highest priority is executed first, and the task with the next highest priority is executed next and so on until there are no more tasks in ready, or pending, state.

In the case where there are no tasks pending execution in iTRON system execution control is passed to Linux, where, again, the task with highest execution priority is executed first. To keep latencies reasonably small, all SRT tasks have higher execution priority than standard Linux processes (i.e., the NRT tasks). In the preferred embodiment, the priority system in Linux between SRT and NRT is implemented using Linux ‘RT priority’. Thus, no NRT process is executed until there are no SRT tasks pending execution. In alternate embodiments, any suitable public domain or proprietary priority management system may be implemented to manage the priority and scheduling of the HRT, SRT, and NRT processes.

As previously alluded to, another novel aspect of the present invention is the process by which multiple kernels can share resources such as file systems, device drivers, libraries etc. In one embodiment of the present invention, this resource sharing process is achieved by defining a dummy API call for each kernel for which resource sharing is supported. For example, without limitation, it is highly desirable to use the features available in a RTOS kernel, e.g., iTRON, from a GPOS kernel, e.g., Linux. A dummy API call for iTRON kernel is presented below by way of example, and not limitation, in pseudo code:

```
#define ITRON_BAS_ERR  300
int itron_syscall(signed long function_id, unsigned long argc,
unsigned long * arg_type, unsigned long * arg_arr)
{ switch(function_id)
  {
/************************************************/
/*  function codes  */
/************************************************/
  /* Section 4.1 Task Management Service Calls */
  case TFN_CRE_TSK:/*(−0x05)*/
  case TFN_DEL_TSK:/*(−0x06)*/
  case TFN_ACT_TSK:/*(−0x07)*/
/* Section 4.4.1 Semaphore Service Calls */
case TFN_CRE_SEM:/*(−0x21)*/
return (cre_sem((ID)arg_arr[0], (T_CSEM *)arg_arr[1]) -
ITRON_BAS_ERR);
case TFN_DEL_SEM:/*(−0x22)*/
return (del_sem((ID)arg_arr[0]) - ITRON_BAS_ERR);
case TFN_SIG_SEM:/*(−0x23)*/
return (sig_sem((ID)arg_arr[0]) - ITRON_BAS_ERR);
  default:
return INVALID_FUNCTION }
}
```

When the secondary kernel is activated (loaded) for the first time as a dynamic run time module, the dummy API call is linked to actual API. When iTRON is activated under Linux as a dynamic module, the dummy API call is replaced by actual API call. In this way, the entire secondary kernel (e.g., iTRON in this example) API's is made available to primary kernel (e.g., Linux in this example) as exemplified without limitation in the following pseudo-code:

asmlinkage int sys_duet_sys_call(signed long kernel_id, signed
long function_id, unsigned long argc, unsigned long *arg_type,
unsigned long *arg_arr)
{
if(duetptr2arr[kernel_id][2])
return duetptr2arr[kernel_id][2](function_id. argc, arg_type, arg_arr);
else
return INVALID_KERNEL_; /* Invalid Kernel */
}
duetptr2
duetptr2arr[DUET_NUM_KERNELS][DUET_NUM_POINTERS] =
{
{linux_sys_call , 0 , 0 },
{ 0 , 0 , 0 }
};

To activate the present embodiment to a run time dynamic module of Linux, the following pseudo-code may be used by way of example and not limitation:

void duet_init_itron(void)
{/* Set duet schedule, IRQ */
duetptrarr[1][0] = itron_schedule;
duetptrarr[1][1] = itron_IRQ;
duetptr2arr[1][2] = itron_syscall;/* Install itron_syscall */
duet_imaskc = 0x000000D0;
duet_imasks = 0x00000000;}

When the RTOS module, e.g., iTRON, is removed the dummy API is removed as exemplified without limitation in the following pseudo-code:

void duet_deinit_itron(void)
{
duetptr2arr[1][2] = 0;/* Uninstall itron_syscall */
duet_imaskc = 0x000000F0;
duet_imasks = 0x00000000;
}

In this, or similar, way, by using the dummy API calls, the primary kernel can execute the secondary kernel functions that are specifically made available to primary kernel through the dummy API. It is contemplated that this mechanism enables use of complex interaction between two kernels including, but not limited to, data sharing, task synchronization and communication functions (semaphores, event flags, data queue, mailboxes). By using dummy API and using GPOS (e.g., Linux) system calls those skilled in the art, in light of the teachings of the present invention, can develop programs that can access rich features rich features of Linux (e.g. file systems, drivers, network, etc.) in real-time embedded programs. Some embodiments of the present invention may not include the foregoing common scheduler and/or common dummy API, as they are optional. That is, with the common interrupt handler of the present invention, multiple kernels may run without a common scheduler and/or common dummy API. However, in many applications a common scheduler provides increased performance and better error handling. Applications that do not require resource sharing among the multiple kernels may not implement the foregoing common dummy API aspect of the present invention.

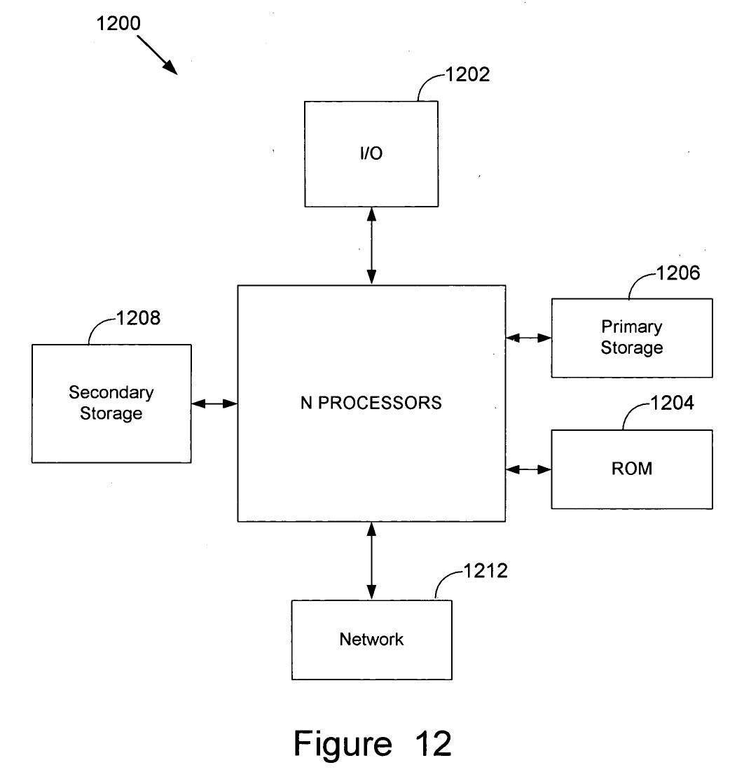

FIG. 12 illustrates a typical computer system that, when appropriately configured or designed, can serve as a computer system in which the invention may be embodied. The computer system 1200 includes any number of processors 1202 (also referred to as central processing units, or CPUs) that are coupled to storage devices including primary storage 1206 (typically a random access memory, or RAM), primary storage 1204 (typically a read only memory, or ROM). CPU 1202 may be of various types including microcontrollers and microprocessors such as programmable devices (e.g., CPLDs and FPGAs) and unprogrammable devices such as gate array ASICs or general purpose microprocessors. As is well known in the art, primary storage 1204 acts to transfer data and instructions uni-directionally to the CPU and primary storage 1206 is used typically to transfer data and instructions in a bi-directional manner. Both of these primary storage devices may include any suitable computer-readable media such as those described above. A mass storage device 1208 may also be coupled bi-directionally to CPU 1202 and provides additional data storage capacity and may include any of the computer-readable media described above. Mass storage device 1208 may be used to store programs, data and the like and is typically a secondary storage medium such as a hard disk. It will be appreciated that the information retained within the mass storage device 1208, may, in appropriate cases, be incorporated in standard fashion as part of primary storage 1206 as virtual memory. A specific mass storage device such as a CD-ROM 1214 may also pass data uni-directionally to the CPU.

CPU 1202 may also be coupled to an interface 1210 that connects to one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 1202 optionally may be coupled to an external device such as a database or a computer or telecommunications or internet network using an external connection as shown generally at 1212. With such a connection, it is contemplated that the CPU might receive information from the network, or might output information to the network in the course of performing the method steps described in the teachings of the present invention.

Those skilled in the art will readily recognize, in accordance with the teachings of the present invention, that any of the foregoing steps and/or system modules may be suitable replaced, reordered, removed and additional steps and/or system modules may be inserted depending upon the needs of the particular application, and that the methods and systems of the present embodiment may be implemented using any of a wide variety of suitable processes and system modules, and is not limited to any particular computer hardware, software, RTOS, GPOS, firmware, microcode and the like.

Having fully described at least one embodiment of the present invention, other equivalent or alternative methods of concurrent execution of and sharing of resources between multiple kernels according to the present invention will be apparent to those skilled in the art. The invention has been described above by way of illustration, and the specific embodiments disclosed are not intended to limit the invention to the particular forms disclosed. The invention is thus to cover all modifications, equivalents, and alternatives falling within the spirit and scope of the following claims.

What is claimed is:

1. A method for the concurrent execution of multiple kernels in a multi-kernel environment the method comprising the Steps of:
selecting a primary kernel from the multi-kernel environment;
starting said primary kernel;
adding at least one secondary kernel, said at least one secondary kernel being under at least partial control of said primary kernel; and
making an interrupt handler a common interrupt handler that handles the interrupts and execution of interrupting processes in said primary and at least one of said secondary kernels.

2. The multi-kernel execution method of claim 1, wherein said primary kernel is capable of being a general purpose operating system.

3. The multi-kernel execution method of claim 1, wherein at least one of said at least one secondary kernels is capable of being a realtime operating system.

4. The multi-kernel execution method of claim 1, wherein the kernel selected as said primary kernel is the kernel in the multi-kernel environment having the most desirable capabilities.

5. The multi-kernel execution method of claim 1, further comprising the step of making a scheduler a common scheduler that schedules execution of processes pending in said primary and at least one of said secondary kernels.

6. The multi-kernel execution method of claim 5, wherein said common scheduler is selected from an operating system in the multi-kernel environment having the most desirable capabilities.

7. The multi-kernel execution method of claim 1, wherein said common interrupt handler is selected from an operating system in the multi-kernel environment having the most desirable capabilities.

8. The multi-kernel execution method of claim 5, wherein said common interrupt handler or said common scheduler is in said primary kernel.

9. The multi-kernel execution method of claim 1, wherein upon booting a computer executing the multi-kernel environment, said primary kernel is started before said at least one secondary kernels.

10. The multi-kernel execution method of claim 1, wherein at least one of said at least secondary kernels is activated as run time dynamic module of said primary kernel.

11. The multi-kernel execution method of claim 1, further comprising the Steps of:
assigning a unique kernel identification to the primary kernel; and
assigning at least one interrupt mask level to the primary kernel, the at least one interrupt mask level determining the interrupts that are allowed for said primary kernel.

12. The multi-kernel execution method of claim 1, further comprising the Steps of:
assigning a unique kernel identification to said at least one secondary kernel; and
assigning at least one interrupt mask level to at least one secondary kernel, the at least one interrupt mask level determining the interrupts that are allowed for the particular secondary kernel.

13. The multi-kernel execution method of claim 5, further comprising the Step of installing a hook for said at least one secondary kernel in said common scheduler or said common interrupt handler of said primary kernel

14. The multi-kernel execution method of claim 1, further comprising the Step of executing a task that switches process execution control from a currently active kernel to a next active kernel, which next active kernel is one of said at least one secondary kernels.

15. The multi-kernel execution method of claim 14, wherein said process execution control task is a periodic task, and the next active kernel is determined by polling, according to a secondary kernel polling priority scheme, said secondary kernels for the highest priority secondary kernel having at least one pending process to execute, process execution control being transferred to said primary kernel after completion of at least a portion of said pending processes in said at least one secondary kernels.

16. The multi-kernel execution method of claim 1, further comprising the Step of invoking said common interrupt handler, said common interrupt handler thereafter executing at least one kernel independent interrupt handling function and passing process execution control to an interrupt service routine of a target kernel associated with the interrupt.

17. The multi-kernel execution method of claim 16, wherein the target kernel is determined by the mask levels of said at least one secondary kernel.

18. The multi-kernel execution method of claim 5, further comprising the Steps of:
invoking said common scheduler;
determining which kernel in the multi-kernel environment currently executing kernel;
transferring process execution control to the currently executing kernel; and,
executing at least one kernel specific scheduling function by the current kernel.

19. The multi-kernel execution method of claim 1, further comprising the Steps of:
the primary kernel passing process execution control to one of said at least one secondary kernels, which, thereby, becomes an active kernel;
the primary kernel changing its interrupt mask levels to correspond to the active kernel; and
the primary kernel changing a currently running kernel identification code to an identification code associated with the active kernel.

20. The multi-kernel execution method of claim 1, further comprising the Step of installing an application program interface (API) for resource sharing between said primary and said at least one secondary kernels.

21. A method for sharing system resources between multiple kernels in a multi-kernel environment, the method comprising the Steps of:
selecting a primary kernel from the multi-kernel environment;
starting said primary kernel;
adding at least one secondary kernel, said at least one secondary kernel being under at least partial control of said primary kernel; and
installing an application program interface (API) for system resource sharing between a first of said primary or said at least one secondary kernels and a second of said primary or said at least one secondary kernels, said first kernel being provided with an appropriate dummy API call for at least said second kernel.

22. The system resource sharing method of claim 21, further comprising the Step of upon said second kernel being activated by said dummy API call from said first kernel, said second kernel replaces said dummy API call in a kernel in which said dummy API was defined, with an actual API call for said second kernel.

23. The system resource sharing method of claim 22, further comprising the Step of executing, upon said actual API call from said first kernel, a specific system function of said second kernel, thereby making available resources of said second kernel in said first kernel.

24. A system for the concurrent execution of multiple kernels in a multi-kernel environment, the system comprising:
means for selecting a primary kernel from the multi-kernel environment;
means for adding and at least partial controlling at least one secondary kernel;
means for executing said primary kernel and said at least one secondary kernel;
means for handling the interrupts and execution of interrupting processes in said primary and at least one of said secondary kernels.

25. The multiple kernel system of claim 24 further comprising means for scheduling the execution of processes pending in said primary and at least one of said secondary kernels.

26. A system for sharing system resources between multiple kernels in a multi-kernel environment, the system comprising:
means for selecting a primary kernel from the multi-kernel environment;
means for adding and at least partial controlling at least one secondary kernel;
means for executing said primary kernel and said at least one secondary kernel; and,
means for system resource sharing between a first of said primary or said at least one secondary kernels and a second of said primary or said at least one secondary kernels.

27. A computer program product for the concurrent execution of multiple kernels in a multi-kernel environment, the computer program product comprising:
computer code that selects a primary kernel from the multi-kernel environment;
computer code that adds and at least partial controls at least one secondary kernel;
computer code that executes said primary kernel and said at least one secondary kernel;
computer code that implements a common interrupt handler that handles the interrupts and execution of interrupting processes in said primary and at least one of said secondary kernels; and,
a computer-readable medium that stores the computer code.

28. A computer program product according to claim 27 further comprising computer code that implements a common scheduler that schedules execution of processes pending in said primary and at least one of said secondary kernels;

29. A computer program product according to claim 27, wherein the computer-readable medium is one selected from the group consisting of a data signal embodied in a carrier wave, a CD-ROM, a hard disk, a floppy disk, a tape drive, and semiconductor memory.

30. A computer program product for sharing system resources between multiple kernels in a multi-kernel environment, the computer program product comprising:
computer code that selects a primary kernel from the multi-kernel environment;
computer code that adds and at least partial controls at least one secondary kernel;
computer code that executes said primary kernel and said at least one secondary kernel;
computer code that shares system resources between a first of said primary or said at least one secondary kernels and a second of said primarily or said at least one secondary kernels,
computer code that provides said first kernel being with an appropriate dummy application program interface (API) call for at least said second kernel; and,
a computer-readable medium that stores the computer code.

31. The system resource sharing method of claim 30, further comprising computer code that, upon said second kernel being activated by said dummy API call from said first kernel, replaces said dummy API call in a kernel in which said dummy API was defined, with an actual API call for said second kernel.

32. The system resource sharing method of claim 30, further comprising computer code that executes, upon said actual API call from said first kernel, a specific system function of said second kernel, thereby making available resources of said second kernel in said first kernel.

33. A computer program product according to claim 30, wherein the computer-readable medium is one selected from the group consisting of a data signal embodied in a carrier wave, a CD-ROM, a hard disk, a floppy disk, a tape drive, and semiconductor memory.
